(19) United States
(12) Patent Application Publication
(10) Pub. No.: US 2011/0076207 A1
(43) Pub. Date: Mar. 31, 2011

(54) METHOD AND APPARATUS FOR PROTECTING AND MONITORING THE KINETIC PERFORMANCE OF AN ESTERIFICATION CATALYST MATERIAL

(75) Inventors: Anthony Tirio, Pittsburgh, PA (US); George Dimotsis, Lansdale, PA (US)

(73) Assignee: LANXESS SYBRON CHEMICALS INC., Birmingham, NJ (US)

(21) Appl. No.: 12/568,792

(22) Filed: Sep. 29, 2009

(51) Int. Cl. B01J 8/04; G01L 7/00; G01K 3/14

(52) U.S. Cl. 422/632; 73/700; 374/137

(57) ABSTRACT

A process for monitoring the condition of a guard bed catalyst material used in an adiabatic reactor to thereby protect a primary reaction catalyst and, in particular, the present invention is intended to be applied to a guard bed used prior to the heterogeneous catalyzed esterification of free fatty acids with low molecular weight monohydric alcohols, especially methanol, to produce fatty acid alkyl esters for biodiesel production.

This invention relates to a procedure for monitoring the condition of a catalytic guard bed used in an adiabatic reactor mode to thereby protect a primary reaction catalyst. Application of the present invention may include a guard bed used prior to the heterogeneous catalyzed esterification of free fatty acids with low molecular weight monohydric alcohols, such as methanol, to produce fatty acid alkyl esters for biodiesel production.

Wide interest in renewable resources to replace petroleum-based transportation fuels led to a rapid increase in the production and number of producers of biodiesel. It is known that fatty acid alkyl esters may be used as a fuel for diesel engines. One method for the production of biodiesel utilizes oils having elevated levels of free fatty acid (FFA), which are less expensive than higher quality oil feeds. Such oils may be the result of degraded vegetable oils as well as mixtures of vegetable oil with animal fats. Sources of such typical oils are, for example, yellow grease which may contain up to 20% by weight FFA and brown grease that can contain even higher levels of FFA. Both have been considered as low cost feed oils for biodiesel production. Further examples of high FFA containing oils include pork and chicken fat, beef tallow, and lower purity vegetable oils. Such oils, however, are known to cause considerable operating problems in biodiesel transesterification reactors when used untreated including significant yield losses. High FFA containing feed oils can contain much higher levels of FFA (typically 5%-20%) and soaps than are contained in fresh refined, degummed and bleached vegetable based oils (RDB oils). They also generally contain varying amounts of phospholipids and other (in)organic contaminates and solids. By comparison RBD oils are clean, low in FFA content (generally about 0.5%), and suitable for direct introduction to a base-catalyzed transesterification process designed to produce biodiesel without expectation of major side reactions. However, with appropriate pretreatment, high FFA containing oils can also be used to efficiently produce biodiesel as well.

One process for pre-treating low cost, high FFA containing biodiesel feedstock utilizes a resin-based solid phase catalyst, such as Lewatit® GF-101 available from LANXESS Deutschland GmbH. This process is described in U.S. Pat. No. 4,698,186, which is hereby incorporated by reference. Lewatit® GF-101 is a strongly acidic, macroporous, polymer-based resin catalyst with sulfonic acid groups suited for esterification reactions. The heterogeneous catalyst can be used in a fixed bed mode and upon contact with a high FFA containing oil in the presence of a monohydric alcohol, such as methanol, sufficient FFA is converted to fatty acid alkyl esters so as to eliminate the negative effects of the high levels of FFA in the biodiesel transesterification reactor. The solid phase catalyst, however, is sensitive to poisons and contaminants that may be contained in low cost, high FFA biodiesel feedstock. Such contaminants and poisons include, for example, cations associated with saponified FFA soaps, which can exchange ions with the acidic catalyst sites of the resin, thereby deactivating the catalyst, along with various organic and inorganic materials including phospholipids which can be present as gummy material that blind the catalyst and reduces its activity.

A high FFA containing oil feedstock may be processed through a polishing step prior to FFA esterification with the use of a guard bed to remove trace residual soap, phospholipids and other fouling agents that would otherwise deactivate the solid phase catalyst. Broadly, such a guard bed may comprise sacrificial solid phase strongly acidic resin of the same or different type as the esterification catalyst that sorbs materials that would otherwise deactivate the primary esterification catalyst. As such, the guard bed can be placed upstream of the main reactor as depicted in FIG. 1. This type of guard bed will perform its required function until such time as its capacity to remove cations and solids is exhausted.

Once the protective capacity of the guard bed is exhausted, the poisons and contaminants of the feedstock will flow into the main esterification reaction vessel and begin to deactivate the catalyst of the main reactor. Thus, upon exhaustion, the guard bed esterification catalyst material must be replaced or regenerated. Regeneration of the guard bed may include backwashing to remove solids and acid washing to drive cations from the bed and replace them with hydrogen ions.

### BRIEF SUMMARY OF THE INVENTION

Surprisingly, it has now been found that where a guard bed reactor, employing guard bed esterification catalyst, is used to protect high value esterification catalyst in a primary chemical reactor (e.g., FFA esterification) via the guard bed esterification catalyst's ability to reduce and/or eliminate poisons and containments from entering the primary esterification reactor vessel housing the high value esterification catalyst, a monitoring system can be utilized to monitor the guard bed esterification catalyst's kinetic performance so as to determine the protective capacity of the guard bed reactor for eliminating poisons and contaminants from the primary esterification reactor and thereby allow for the further useful and protected employment of the primary esterification catalyst.

In such a monitoring process, the guard bed reactor vessel can be converted to a smaller version of the primary reactor vessel. Thereafter by directing the full or partial flow of reactants (e.g., high FFA oil feedstock and monohydric alcohol) to this guard bed reaction vessel, while being operated adiabatically under designated conditions of temperature and pressure, the guard bed reactor will act as a highly responsive version of the primary esterification reactor. Any loss of catalytic activity or accumulation of solid materials by the guard bed esterification catalyst will result in changes in temperature and pressure across the guard bed reaction vessel. For example, the observation of an increase in deferential pressure across the guard bed reactor is indicative of contaminant solids build up and catalyst blinding. In addition, a reduction in differential temperature across the guard bed reactor would be indicative of catalyst poisoning and/or blinding.

In a preferred embodiment of the invention there is disclosed an apparatus for protecting a primary esterification catalyst, comprising: a) a guard bed reaction vessel having a first inlet, a first outlet, an first interior region, and a guard bed esterification catalyst, wherein said guard bed esterification catalyst is disposed within said first interior region between said first inlet and said first outlet so as to thereby enable a first fluid stream comprising FFA and catalyst-contaminants to enter the guard bed reaction vessel through said first inlet, contact the guard bed esterification catalyst, thereby forming an effluent stream, and allowing said effluent stream to exit the guard bed reaction vessel via the first outlet; b) a primary reaction vessel having a second inlet, a second outlet, a second interior region, and the primary esterification catalyst, wherein said primary esterification catalyst is disposed within said second interior region between said second inlet and said second outlet so as to thereby enable the effluent stream to enter the primary reaction vessel through said second inlet, contact the primary esterification catalyst, thereby forming a final stream and allowing said final stream to exit the primary reaction vessel via the second outlet; c) a reactor preheater for heating the first fluid stream; d) a conduit, interposed between the reactor preheater, the guard bed reaction vessel, and the primary reaction vessel, thereby allowing the flow of a fluid between them; e) a guard bed temperature monitor connected to the guard bed reaction vessel for measuring the temperature differential across a portion of the guard bed; and f) a guard bed pressure monitor connected to the guard bed reaction vessel for measuring the pressure differential across a portion of the guard bed. In a further embodiment, said primary esterification catalyst is a solid phase strongly acidic resin-based catalyst that may be macroporous. In a further embodiment, a solid phase strongly acidic resin-based catalyst comprises a sulfonated styrene-divinylbenzene based polymeric resin.

In another embodiment of the invention there is disclosed a process for protecting a primary esterification catalyst in which an apparatus for protecting a primary esterification catalyst in accord with that described above is used to heat a first fluid stream prior to its introduction into the guard bed reaction vessel and in which the temperature differential across a portion of the guard bed esterification catalyst is measured with or without the measuring of the pressure differential across all and/or a portion of the guard bed esterification catalyst. In a further embodiment the primary esterification catalyst used in the disclosed process is a solid phase strongly acidic resin-based catalyst that may be microporous and may include the use of a sulfonated styrene-divinylbenzene based polymeric resin. For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF DRAWINGS

FIG. 1 schematically illustrates a general catalysis process for converting FFA to alkyl esters employing a guard bed prior the main reactor.

FIG. 2 schematically illustrates an exemplary embodiment of a process for converting FFA to alkyl esters according to the present invention, wherein the temperature of the guard bed inlet stream is controlled.

FIG. 3 schematically illustrates an exemplary embodiment of a process for converting FFA to alkyl esters according to the present invention, wherein the temperature of the guard bed outlet stream is controlled.

FIG. 4 plots the expected differential temperature across the guard bed relative to the reactive capacity of the guard bed.

### DETAILED DESCRIPTION OF THE PREFERRED EMBODIMENTS

Although the instant description pertains to the esterification reaction of free fatty acids (FFA) with alcohol to thereby form fatty acid alkyl esters (FAME), the present invention can be extended to other variations of esterification reactions, as well as other chemical reactions having both positive and negative heats of reaction. The following description pertains to a process of treating a triglyceride containing oil having appreciable levels of free fatty acids in an esterification reactor whereby FFA is reacted with methanol to form fatty acid methyl esters. Such an esterification reaction can be conducted in the presence of a solid sulfonic acid resin catalyst, however, it should be appreciated that the esterification reaction is applicable to other heterogeneous catalysts such as, for example, immobilized enzymes and solid phase organo-metallic esterification catalysts, such as, for example, tin impregnated resins.

The esterification reaction combines an organic acid, such as a free fatty acid, with an alcoholic compound, such as methanol or ethanol, to form an ester compound and a byproduct, such as water as shown by the following reaction:

R₁—COOH+R₂—OH→R₁—CO—OR₂+H₂O (1),

where R₁ is straight chain or branched, saturated or unsaturated, substituted or unsubstitued, acyclic, C₄-C₂₈ alkyl; and R₂ is an aliphatic hydrocarbon. R₁ may include synthetic and naturally occurring free fatty acids, for example R1 may include those fatty acids naturally occurring in animal and vegetable fats, the latter of which may include coconut oil, palm oil, cottonseed oil, wheat germ oil, soya oil, olive oil, corn oil, sunflower oil, safflower oil, hemp oil, rapeseed oil, canola oil, and/or palm oil. R₂ may include C₁-C₄ alkyl, including methyl and ethyl groups. Furthermore, one skilled in the art will recognize that R₁ and R₂ can represent a myriad of chemical compounds that would fit within the concept of an esterification reaction.

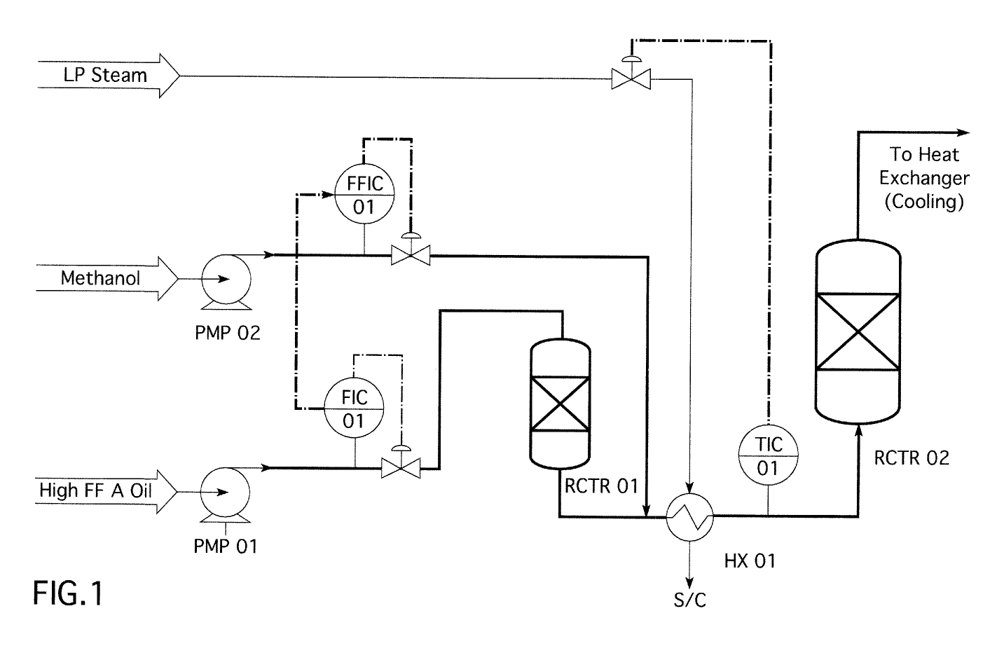

For commercial purposes, the esterification reaction of FFA is too slow without the aid of high temperature and catalysts. The use of acid catalysts to increase the reaction rate of esterification reactions is well documented. As shown in FIG. 1 there is provided the traditional method of employing a guard bed reaction vessel in a typical heterogeneous catalysis process for converting FFA to FAME. A pump PMP 01 flows feed oil having a high level of FFA and contaminants under flow control of flow control indicator FIC 01 to a guard bed vessel RCTR 01. Within the guard bed reaction vessel RCTR 01 the feed oil is brought into contact with guard bed material which allows for the sorption of contaminents. Thereafter an effluent stream exits the guard bed reaction vessel RCTR 01. Another pump PMP 02 flows methanol under flow ratio control of flow ratio indicator control FFIC 01 to combine, with the effluent to form a mixed effluent stream that is then directed into the primary esterification reaction vessel RCTR 02. However, prior to the introduction into the primary esterification reaction vessel RCTR 02, the mixed effluent stream in preheated via preheater HX 01. Preheater HX 01 utilizes low pressure stream, designated LP Steam, to heat the mixture of oil and methanol by condensing steam. The flow rate of LP Steam is regulated by temperature indicator and control TIC 01 to raise and maintain the desired temperature of the mixed effluent stream prior to introduction to the primary esterification reaction vessel RCTR 02 to, thereby, assure the desired reaction rate.

In the typical reactor system of FIG. 1, there is no efficient mechanism to monitor the protective capacity of the guard bed material. Periodic withdrawal of representative samples of the guard bed material contents is expensive, time consuming and potentially dangerous. In such systems when solid contamination is introduced to the guard bed material, the differential pressure is increased. While this effect could potentially be monitored by observing the output signal from a flow controller over a period of time, the method is neither as sensitive nor as responsive as measuring differential pressure across the guard bed reaction vessel. If ionic contamination is introduced to the guard bed material in the typical system of FIG. 1 there is no way to measure the decrease in catalyst activity except be withdrawing catalyst material and performing activity testing. In addition to not having the required instrumentation, there is no reaction taking place in the guard bed material because all of the required reactants are not present and because the fluid in the guard bed is not hot enough for any reasonable extent of the reaction to take place.

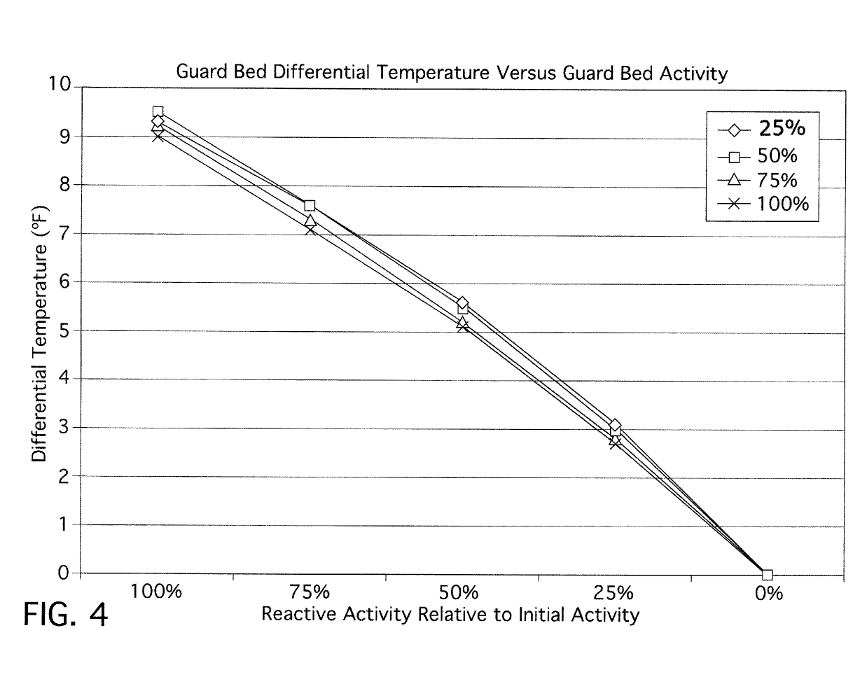

The problems described above for the typical system as shown in FIG. 1 are overcome by the lessons of this invention. Since typical esterification reactions are slightly endothermic they tend to consume heat from their surroundings. Therefore, if such an endothermic reaction is performed in an adiabatic reactor, that is, one which does not permit heat to enter or leave the reaction zone, a decrease in temperature will be realized. This change in temperature can be correlated with the extent of reaction, that is, the change in temperature is proportional to the amount of heat consumed by an endothermic reaction or released by an exothermic reaction provided that no phase change is permitted. In various embodiments of this invention, vaporization of reactants and products is suppressed by the endothermic nature of the esterification reaction. In exothermic reactions, vaporization of reactants and products can be suppressed maintaining adequate pressure. As the reactive activity of the catalyst in the reactor decreases due to aging, poisoning or degradation caused contamination, the extent of reaction and corresponding differential temperature will decrease. This phenomenon is, for example, illustrated in the chart shown in FIG. 4. At the initial conditions where the catalyst has full activity, the differential temperature is approximately 10° F. As activity decreases due to degradation of the catalyst resulting from ionic exchange of active catalyst sites with a contaminant such as sodium ion, the extent of reaction will decrease and the differential temperature across the bed will also decrease, accordingly.

Further, to monitor the filtering capacity of the guard bed, differential pressure across the guard bed reaction vessel RCTR 01 can also be measured. As long as the flow rate of the fluid flowing into the guard bed reaction vessel RCTR 01 and temperature either into or out of the guard bed reaction vessel RCTR 01 are controlled, any increase in the differential pressure measured across the guard bed material and/or the guard bed reaction vessel RCTR 01 will be indicative of pluggage and/or degradation of the contents of the guard bed esterification catalyst material.

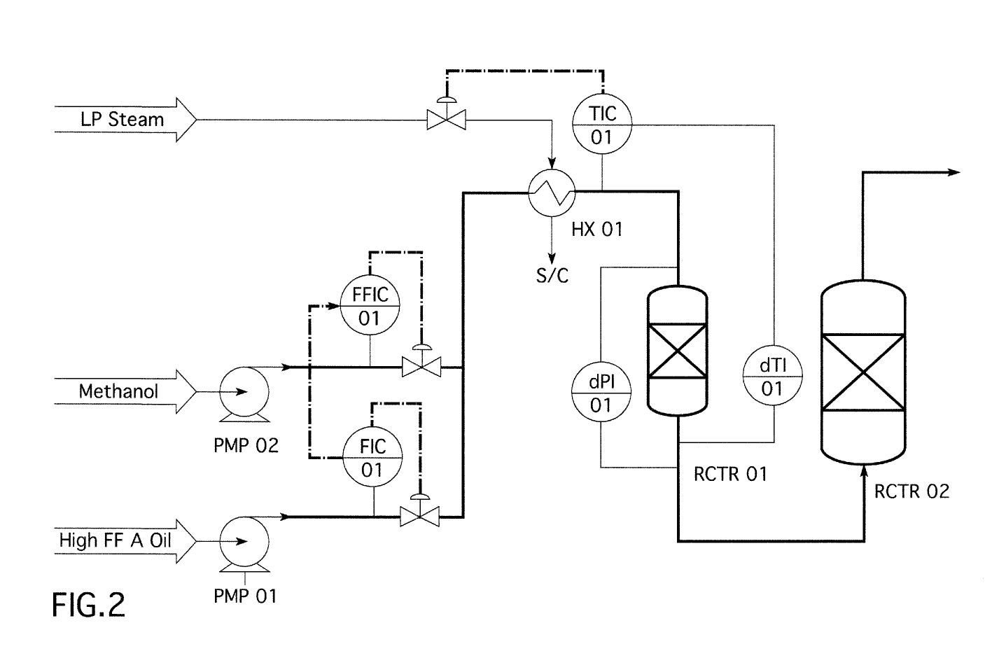

As shown in FIG. 2 there is an embodiment of the present invention that improves upon the typical heterogeneous catalysis process by adding both temperature gradient and pressure gradient monitoring, namely, the measuring of differential pressure, via a differential pressure indicator dPI, and measuring of differential temperature via a differential temperature indicator dTI across the guard bed reaction vessel RCTR 01. Thus, the differential pressure indicator dPI and the differential temperature indicator dTI are used to monitor the change in differential pressure and differential temperature conditions, respectively. As shown, the differential pressure and differential temperature measurements may be made across the entire reactor guard bed reaction vessel RCTR 01. However, as can be appreciated by one skilled in the art, the differential pressure and temperature measurements could also be made across a predetermined section of the guard bed esterification catalyst.

As shown in FIG. 2, a pump PMP 01 is used to flow a feed oil having high levels of FFA and other contaminants under flow control of flow control indicator FIC 01 into the system. In addition, another pump PMP 02 is used to flow monohydric alcohol, in this instance methanol, under flow ratio control of flow ratio control indicator FFIC 01 into the system. The high FFA content feed stream is combined with the methanol feed to form a first fluid stream comprising, inter alia, FFA, contaminants, and methanol. The combined first fluid stream then flows to a reactor preheater HX 01 and thereafter into the guard bed reaction vessel RCTR 01 via an inlet thereto.

Prior to the introduction of the first fluid stream into the guard bed reaction vessel RCTR 01, as shown in FIG. 2, preheater HX 01 heats the combined first fluid stream by condensing steam. Preheater HX 01 may utilize low pressure stream, designated LP Steam in FIG. 2. However, it should also be understood, that another manner of heating such as for example direct fired, oil heat or process interchange may also be employed as heating means for the first fluid stream. The flow rate of LP Steam is regulated by the temperature indicator and controller TIC 01 to thereby maintain the desired temperature of the first fluid stream prior to its introduction to the guard bed reaction vessel RCTR 01. This control enables accurate measures of the differential temperature and differential pressure across the guard bed reaction vessel RCTR 01 to be performed.

Housed within the guard bed reaction vessel RCTR 01 is the guard bed esterification catalyst. As discussed infra, the guard bed esterification catalyst in the preferred embodiment is a strongly acidic, polymeric resin being in a substantially spherical bead form and having sulfonic acid groups as part thereof. For example such a polymeric resin may be based on a sulfonated styrene-divinylbenzene bead polymer. Furthermore, the strongly acidic resins of the present invention can have a gel-type or macroporous structure and are preferably monodispersed.

The entry of the first fluid into the guard bed reaction vessel RCTR 01 allows for contact to occur between the guard bed esterification catalyst and the first fluid stream and, moreover, between the guard bed esterification catalyst and the FFA and other contaminants of the first fluid stream. In turn the catalyzed esterification reaction of the FFA occurs whereby FAME is produced. As more fully discussed supra, both the differential pressure and differential temperature is monitored to thereby determine the exhaustion of the guard bed esterification catalyst as indicated by the decrease in differential temperature and/or increase in differential pressure. It should be understood, however, that without the use of temperature indicator and controller TIC 01, the measurements of the deferential temperature and pressure across the entire guard bed reaction vessel and/or a portion thereof could not be performed with sufficient accuracy necessary to monitor the state of exhaustion and blinding of the guard bed esterification catalyst, since the reaction rate of the FAA esterification reaction is well known to be dependent upon temperature and, to a lesser degree, pressure.

The FFA esterification reaction produces an effluent in which a portion of the FAA has been reacted to produce FAME, but more importantly, an effluent stream in which containments harmful to the primary esterification catalyst have been entirely or substantially removed from the stream. This purified effluent stream then flows from a first outlet of the guard bed reaction vessel RCTR 01 to the primary esterification reaction vessel RCTR 02 via an inlet thereto. The effluent stream is then allowed to contact the primary esterification catalyst so as to enable the reaction of the remaining FFA to FAME.

As is known to the skilled artisan, appropriate conduit can be used to enable the transfer of the fluid, gas, and/or steam streams between pumps, vessels, storage tanks, and other components of the system.

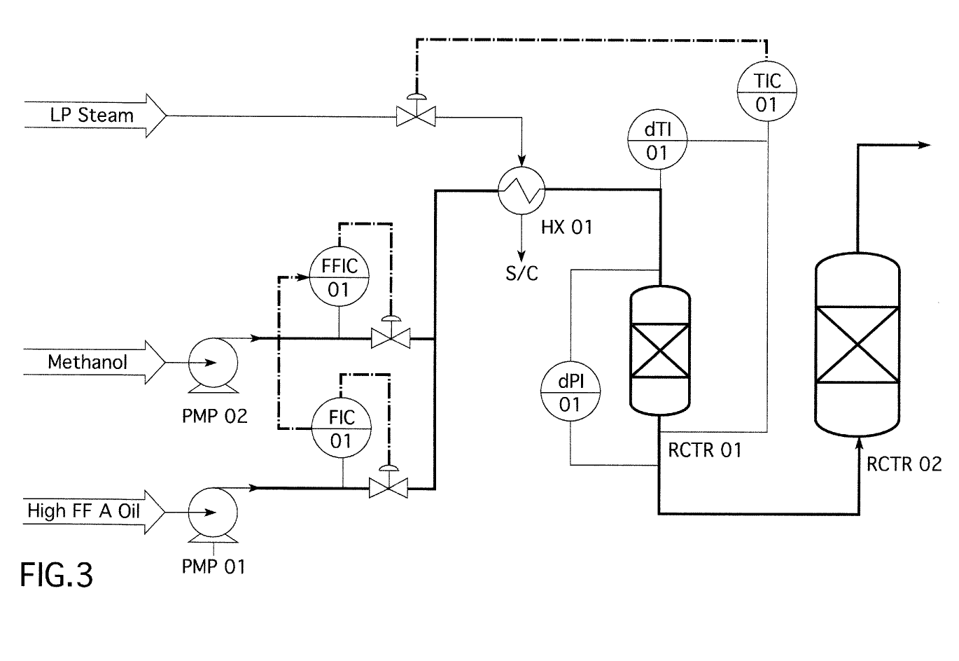

As shown in FIG. 3 there is another embodiment of the present invention that improves upon the typical heterogeneous catalysis process by adding differential pressure and differential temperature monitoring across a guard bed reaction vessel RCTR 01. The differential measurements may be across a portion of the guard bed esterification catalyst and/or across the entire guard bed reaction vessel, the latter of which is depicted in FIG. 3. As was the case in the process of FIG. 2, a feed oil containing high levels of FFA and other contaminants are flowed by a pump PMP 01 under flow control of flow indicator control FIC 01. Additionally, another pump PMP 02 flows monohydric alcohol, e.g., methanol, under flow ratio control of flow ratio indicator control FFIC 01, which is then combined with the high FFA containing feed stream. The combined streams form a first fluid stream that flows to a reactor preheater HX 01. Reactor preheater HX 01 utilizes low pressure steam, designated LP Steam, to heat the first fluid stream by condensing steam. The first fluid stream enters the guard bed reaction vessel which houses the guard bed esterification catalyst and wherein the first fluid stream is then contacted with the guard bed esterification catalyst to allow for an esterification reaction to occur along with the sorption of various contaminants. A purified effluent stream then exits the guard bed reaction vessel RCTR 01 via an outlet having reduced FFA content and, moreover, removed or substantial reduced concentration of contaminates.

Unlike the embodiment of FIG. 2, the flow rate of LP Steam is regulated by temperature indicator and control TIC 01 to thereby maintain the desired temperature of the effluent stream exiting the guard bed reaction vessel RCTR 01. The effluent stream is subsequently directed to the primary esterification reaction vessel RCTR 02 where it is allowed to contact the primary esterification catalyst and further the reaction of FFA to FAME.

As the activity of the guard bed esterification catalyst decreases due to catalyst deactivation, the extent of reaction across the guard bed reaction vessel will decrease with a corresponding decrease in the differential temperature. In this embodiment, the first indication of the loss of activity will be a rise in temperature of the guard bed reaction vessel outlet. The temperature controller regulating the guard bed outlet temperature will respond by reducing heat input to the reactor preheater HX01 thereby decreasing the inlet temperature of the first fluid stream to the guard bed reaction vessel RCTR 01; thereby, maintaining the desired guard bed reaction vessel outlet temperature of the effluent stream. The result of this control action will be indicated by reduced differential temperature sensed by differential temperature indicator dT01. Differential pressure may be monitored as well according to the manner provided in the embodiment of FIG. 2.

It should be understood that appropriate conduit can be used to enable the transfer of the fluid, gas, and/or steam streams between pumps, vessels, storage tanks, and other components of the system.

It should also be appreciated that more than one guard bed could be employed (not shown). For example, it may be preferable to employee two guard beds having the same or different catalyst material. Upon the exhaustion of the first guard bed, the high FFA containing feed stream could be transitioned to the second guard bed. This would allow for the replacement or regeneration of the first guard bed catalyst material without interruption to the overall reactive processing.

The catalyst material, for use as the guard bed esterification catalyst and/or primary esterification reaction catalyst, in at least one embodiment comprises a strongly acidic, polymeric resin being in a substantially spherical bead form and having sulfonic acid groups as part thereof, for example, such a polymeric resin may be based on a sulfonated styrene-divinylbenzene bead polymer. The strongly acidic resins can have a gel-type or macroporous structure and can be monodispersed. The formation of such resins according to the present invention is generally known. Monodispersed as used herein means a polymeric bead resin in which at least 90 vol. or wt. % of the particles have a diameter which lies in the interval around the most frequent diameter with width of +10% of the most frequent diameter. For example, a polymeric bead resin with most frequent bead diameter of 0.5 mm, at least 90 vol. or wt. % lie in a size interval between 0.45 mm and 0.55 mm; for a substance with most frequent diameter of 0.7 mm, at least 90 vol. or wt. % lie in a size interval between 0.77 mm and 0.63 mm.

A monodispersed bead polymerizate required for the production of monodispersed polymeric bead resin can be produced according to the methods known from the literature. For example, such methods and the monodispersed polymeric bead resins made from them are described in U.S. Pat. No. 4,444,961, U.S. Pat. No. 4,419,245, whose contents are fully incorporated by reference. According to the invention, monodispersed bead polymerizates and the monodispersed polymeric bead resins prepared may be obtained by jetting or seed/feed processes.

The terms microporous, macroporous or gel-like have already been described fully in the technical literature related to polymeric bead resins. Preferably the polymeric bead resin according to at least one embodiment of the invention has a macroporous structure. The formation of macroporous bead polymerizates for the production of macroporous polymeric bead resins can take place, for example, by adding inert materials (pore-forming agents) to the monomer mixture during the polymerization. Suitable as such pore-forming agents are, for example, organic substances that dissolve in the monomer, dissolve or swell the polymerizate slightly (precipitating agents for polymers), such as aliphatic hydrocarbons.

As provided above, the use of a strongly acidic, sulfonated, monodisperse, macroporous, styrene-divinylbenzene bead polymer is contemplated as the FFA esterification catalyst of the invention. An example of such a polymer bead resin is Lewatit® GF-101 commercially available from LANXESS Deutschland GmbH.

### EXAMPLES

TABLE 1

| Feed | Guard Bed RCTR01 | | | | | | | |
|---|---|---|---|---|---|---|---|---|
| FFA | | | FFA | | FFA | | | relative |
| in | Relative | T in | in | T out | out | Conv | δT | δT |
| % | Capacity | ° F. | pph | ° F. | pph | % | ° F. | % |
| 25% | 100% | 194.0 | 1252.5 | 184.7 | 789.3 | 37% | 9.30 | 100% |
| 25% | 75% | 194.0 | 1252.5 | 186.4 | 875.2 | 30% | 7.60 | 82% |
| 25% | 50% | 194.0 | 1252.5 | 188.4 | 976.7 | 22% | 5.60 | 60% |
| 25% | 25% | 194.0 | 1252.5 | 190.9 | 1099.7 | 12% | 3.10 | 33% |
| 25% | 0% | 194.0 | 1252.5 | 194.0 | 1252.5 | 0% | 0.00 | 0% |
| 50% | 100% | 194.0 | 2000.0 | 184.5 | 1445.5 | 28% | 9.50 | 100% |
| 50% | 75% | 194.0 | 2000.0 | 186.4 | 1554.5 | 22% | 7.60 | 80% |
| 50% | 50% | 194.0 | 2000.0 | 188.5 | 1679.5 | 16% | 5.50 | 58% |
| 50% | 25% | 194.0 | 2000.0 | 191.0 | 1825.7 | 9% | 3.00 | 32% |
| 50% | 0% | 194.0 | 2000.0 | 194.0 | 2000.0 | 0% | 0.00 | 0% |
| 75% | 100% | 194.0 | 2505.0 | 184.8 | 1909.8 | 24% | 9.20 | 100% |
| 75% | 75% | 194.0 | 2505.0 | 186.7 | 2029.8 | 19% | 7.30 | 79% |
| 75% | 50% | 194.0 | 2505.0 | 188.8 | 2165.7 | 14% | 5.20 | 57% |
| 75% | 25% | 194.0 | 2505.0 | 191.2 | 2322.2 | 7% | 2.80 | 30% |
| 75% | 0% | 194.0 | 2505.0 | 194.0 | 2505.0 | 0% | 0.00 | 0% |
| 100% | 100% | 194.0 | 2867.0 | 185.0 | 2248.6 | 22% | 9.00 | 98% |
| 100% | 75% | 194.0 | 2867.0 | 186.9 | 2375.2 | 17% | 7.10 | 77% |
| 100% | 50% | 194.0 | 2867.0 | 188.9 | 2517.4 | 12% | 5.10 | 55% |
| 100% | 25% | 194.0 | 2867.0 | 191.3 | 2679.6 | 7% | 2.70 | 29% |
| 100% | 0% | 194.0 | 2867.0 | 194.0 | 2867.0 | 0% | 0.00 | 0% |

Illustrative of a preferred embodiment of the present invention, reference is hereby made to Table 1. The data used to generate Table 1 was developed from computer models created with the Aspen Plus steady state simulation software available from AspenTech. The NRTL property system within Aspen Plus was utilized to generate physical and thermodynamic properties.

As provided in Table 1 there is shown an example of how the relative capacity of the guard bed catalyst can be monitored directly from the relative differential temperature measured across the guard bed reaction vessel. Four cases of various FFA content of the feed are provided in the first column (Feed FFA in): 25%, 50%, 75% and 100%, respectively. For each of these concentrations, five levels of catalyst activity are selected and listed in the second column (Guard Bed RCTR01 Relative Capacity): 100%, 75%, 50%, 25%, and 0%. The next four columns pertain to the guard bed operation (inlet temperature (T in), inlet FFA flow rate (FFA in), outlet temperature (T out) and outlet FFA flow rate (FFA out)) and are determined from material and energy balance calculations utilizing a Langmuir-Hinschelwood kinetic model of the guard bed performance. The seventh column designated Conv % is the relative conversion of FFA as the process stream flows across the guard bed catalyst and can be calculated by dividing the change in FFA (FFA in minus FFA out) by the amount of FFA entering the guard bed. The eighth column, differential temperature designated δT, is the temperature difference across the bed (T in minus T out). The final column is the relative differential temperature calculated by dividing δT by the inlet temperature (T in). This information is depicted graphically in FIG. 4 that demonstrates the relationship between guard bed catalyst activity and differential temperature that is utilized in the present invention.

Although the preferred embodiment of the present invention has been described herein with reference to the accompanying drawings and examples, it is to be understood that the invention is not limited to that precise embodiment or examples, and that various other changes and modifications may be affected therein by one skilled in the art without departing from the scope or spirit of the invention.

What is claimed is:

1. An apparatus for protecting a primary esterification catalyst, comprising:
a) a guard bed reaction vessel having a first inlet, a first outlet, an first interior region, and a guard bed esterification catalyst,
wherein said guard bed esterification catalyst is disposed within said first interior region between said first inlet and said first outlet so as to thereby enable a first fluid stream comprising contaminants to enter the guard bed reaction vessel through said first inlet, contact the guard bed esterification catalyst, thereby forming an effluent stream, and allowing said effluent stream to exit the guard bed reaction vessel via the first outlet;
b) a primary reaction vessel having a second inlet, a second outlet, a second interior region, and the primary esterification catalyst,
wherein said primary esterification catalyst is disposed within said second interior region between said second inlet and said second outlet so as to thereby enable the effluent stream to enter the primary reaction vessel through said second inlet, contact the primary esterification catalyst, thereby forming a final stream and allowing said final stream to exit the primary reaction vessel via the second outlet;
c) a reactor preheater for heating the first fluid stream;
d) a conduit, interposed between the reactor preheater, the guard bed reaction vessel, and the primary reaction vessel, thereby allowing the flow of a fluid between them;
e) a guard bed differential temperature monitor connected to the guard bed reaction vessel for measuring the differential temperature across a portion of the guard bed esterification catalyst; and
f) a guard bed differential pressure monitor connected to the guard bed reaction vessel for measuring the differential pressure gradient across a portion of the guard bed esterification catalyst.

2. The apparatus according to claim 1, wherein said primary esterification catalyst is a solid phase strongly acidic resin-based catalyst.

3. The apparatus according to claim 2, where said solid phase strongly acidic resin-based catalyst is macroporous.

4. The apparatus according to claim 3, where said solid phase strongly acidic resin-based catalyst is a sulfonated styrene-divinylbenzene based polymeric resin.

5. A process for protecting a primary esterification catalyst, comprising the steps of:
a) providing the apparatus according to claim 1,
b) heating the first fluid stream prior to the introduction thereof into the guard bed reaction vessel;
c) measuring the differential temperature across a portion of the guard bed esterification catalyst; and
d) measuring the differential pressure across a portion of the guard bed esterification catalyst.

6. The process according to claim 5, wherein said primary esterification catalyst is a solid phase strongly acidic resin-based catalyst.

7. The process according to claim 6, where said solid phase strongly acidic resin-based catalyst is macroporous.

8. The process according to claim 7, where said solid phase strongly acidic resin-based catalyst is a sulfonated styrene-divinylbenzene based polymeric resin.
